(19) United States
(12) Patent Application Publication
(10) Pub. No.: US 2006/0258416 A1
(43) Pub. Date: Nov. 16, 2006

(54) ANALYZER FOR DATA RELATING TO NETWORKED GAMES

(75) Inventor: Lee Crawford, Los Altos, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 11/383,176

(22) Filed: May 12, 2006

Related U.S. Application Data
(60) Provisional application No. 60/680,702, filed on May 13, 2005.

(51) Int. Cl. A63F 13/00

(52) U.S. Cl. 463/1

(57) ABSTRACT

A data warehouse is employed for collecting, multidimensionally analyzing, and publishing statistics and other information relating to a plurality of independent networked games and participants in such games. Data to be added to the data warehouse may be obtained periodically by way of a games monitor. Analyzed data may be used in generating profiles of users and groups of users. Information on game users and groups of users may be employed to provide intelligent matchmaking based on user ability measurements.

### CROSS-REFERENCE TO RELATED APPLICATIONS

This application claims the benefit of U.S. Provisional Application, titled “Analyzer for Data Relating to Networked Games,” Ser. No. 60/680,702 filed on May 13, 2005, the benefit of the earlier filing date of which is hereby claimed under 35 U.S.C. § 119(e), and further is incorporated by reference.

### FIELD OF THE INVENTION

The present invention relates generally to online games, and more particularly, but not exclusively, to collection and analysis of data relating to online multiplayer games.

### BACKGROUND OF THE INVENTION

Multiplayer online games have become increasingly popular as network communications have improved. Users who may be geographically distant from each other may communicate by way of a network to participate together in games and other collaboration services. Typically, a user runs a client program that performs local processing and communicates with a service over a network to coordinate, with other users, joint state for the multi-user game or service. For users to initiate participation in the same online game or online service, users may meet in an online lobby or other matching system that is associated with the online game or online service.

Although game players now have available to them greater and more varied opportunities to participate in online games, they suffer from a lack of useful information regarding the nature of these opportunities. For example, while a user interested in participating in a particular game can now find an available game server for that game with ease using special-purpose browser applications, that user will generally know nothing about the skills and experiences of the players available at that game server. Some providers of specific games have collected and made available limited data regarding the particular games that they provide, but not information regarding games available generally, nor do they provide information relating usage of their own games to usage of other games. Similarly, providers of particular game services have not been able to obtain and produce useful information that accurately describes the behavior of the game players themselves, because such players in general participate in more than one game offered by more than one game provider. The absence of such information for both game service providers and game players has limited the quality of the experience of online game play.

### BRIEF DESCRIPTION OF THE DRAWINGS

Nonlimiting and nonexhaustive embodiments of the present invention are described with reference to the following drawings. In the drawings, like reference numerals refer to like parts throughout the various figures unless otherwise specified.

For a better understanding of the present invention, reference will be made to the following detailed description, which is to be read in association with the accompanying drawings, wherein:

FIG. 1 shows a functional block diagram illustrating one embodiment of an environment for practicing the invention;

FIG. 2 shows one embodiment of a computing device, such as a client or a server device, that may be included in a system implementing the invention;

FIG. 3 illustrates one embodiment of an architecture for the present invention;

FIG. 4 is a flow diagram illustrating exemplary operations for a process that employs a data warehouse or the like for collection and analysis of data relating to games and game users; and

FIG. 5 is a flow diagram illustrating exemplary operations for matching a game user or clan with other game users or clans, in accordance with the invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. The invention may, however, be embodied in many different forms and should not be construed as limited to the embodiments set forth herein. Rather, these embodiments are provided so that this disclosure will be thorough and complete, and will fully convey the scope of the invention to those skilled in the art. Among other embodiments, the present invention may be embodied as methods or devices. Accordingly, the present invention may take the form of an entirely software embodiment, an entirely hardware embodiment or an embodiment combining software and hardware aspects. The following detailed description is, therefore, not to be taken in a limiting sense.

Briefly stated, an aspect of the present invention is directed towards a general mechanism and facility for collecting, analyzing and publishing statistics and other information relating to networked games and their players. Another aspect of the invention is further directed towards employing such information to provide intelligent matchmaking for game users and clans of game users.

Illustrative Operating Environment

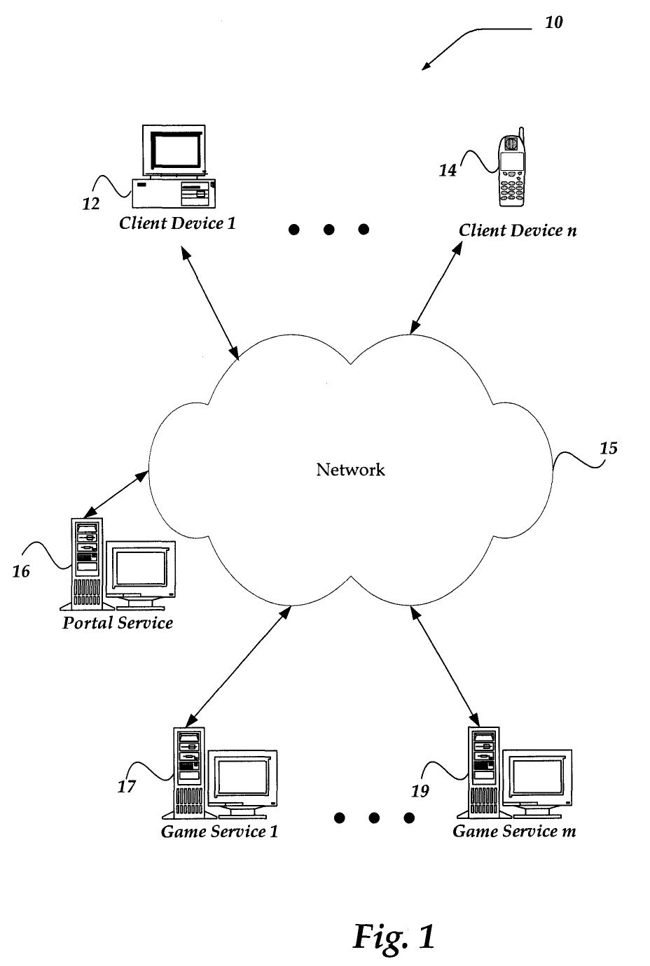

FIG. 1 illustrates one embodiment of an environment in which the present invention may operate. However, not all of these components may be required to practice the invention, and variations in the arrangement and type of the components may be made without departing from the spirit or scope of the invention.

As shown in the figure, a system 10 includes client devices 12-14, a network 15, a portal service 16, and third-party game services 17-19 that may not be directly associated with the portal service 16 (for example, in the sense that the third party game service 17 and the portal service 16 may be operated independently by unrelated entities). Network 15 is in communication with and enables communication among each of client devices 12-14, portal service 16, and game services 17-19.

Client devices 12-14 may include essentially any computing device capable of sending and receiving data over a network, such as network 15, to and from another computing device, such as portal service 16, each other, intermediary devices linked by way of network 15, and the like. The set of such devices may include general-purpose or special-purpose mobile devices that typically connect using a wireless communications medium, such as mobile phones and the like. The set of such devices may also include general-purpose or special-purpose devices that typically connect using a wired communications medium, such as personal computers, networked workstations, microprocessor-based or programmable consumer electronics, and the like. Similarly, client devices 12-14 may include any device that is capable of connecting using a wired or wireless communication medium such as a personal digital assistant (PDA) and any other device that is equipped to communicate over a wired and/or wireless communication medium.

Network 15 is configured to couple one computing device to another computing device to enable them to communicate. Network 15 is enabled to employ any form of medium for communicating information from one electronic device to another. Also, network 15 may include a wireless access network, such as a cellular network, and/or a wired network, and may include one or more interconnected local area networks (LANs), wide area networks (WANs), and any combination thereof. On an interconnected set of LANs, including those based on differing architectures and protocols, a router typically acts as a link between LANs, enabling messages to be sent from one to another. Also, communication links within LANs typically include twisted wire pair or coaxial cable, while communication links between networks may utilize cellular telephone signals over air, analog telephone lines, full or fractional dedicated digital lines, wireless links including satellite links, or other communications links known to those skilled in the art. Furthermore, remote computers and other related electronic devices may be remotely connected to either LANs or WANs by way of a modem and temporary telephone link. In essence, network 15 includes any communication method by which information may travel between or among client devices 12-14, portal service 16, and game services 17-19. Network 15 is constructed for use with various networking protocols, such as those protocols that comprise or support the TCP/IP suite, and the like.

The media used to transmit information in communication links as described above generally include any medium that can be accessed by a computing device. Computer-readable media may include computer storage media, wired and wireless communication media, or any combination thereof. Additionally, computer-readable media may embody computer-readable instructions, data structures, program modules, or other data in a modulated data signal such as a carrier wave, data signal, or other transport mechanism and includes any information delivery medium. The terms “modulated data signal” and “carrier-wave signal” include a signal that has one or more of its characteristics set or changed in such a manner as to encode information, instructions, data, and the like, in the signal.

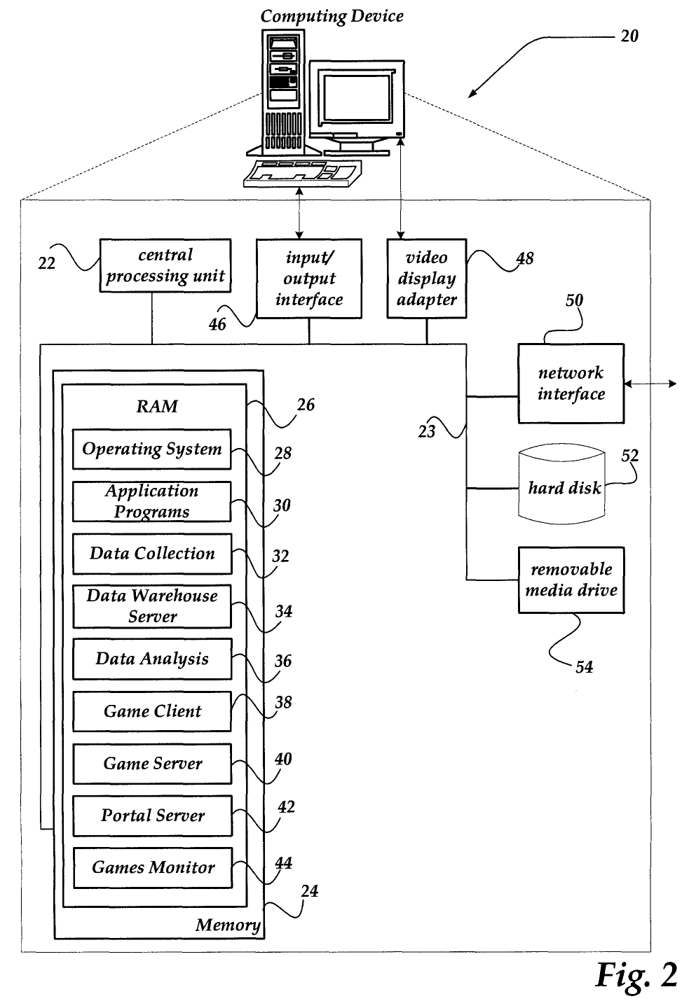

One embodiment of a general-purpose computing device is described in more detail below in conjunction with FIG. 2. Computing device 20 may function as either or both of a client device and a server device with respect to applications that employ a client-server architecture or the like, including applications associated with portal service 16 and/or game service 17. Computing device 20 may also function as a peer-to-peer device with respect to portal service 16 and/or game service 17. Briefly, device 20 may include any computing device capable of connecting to network 15 to enable the device to communicate with client devices, server devices, portal service 16, game service 17, and/or other devices. Device 20 may include many more components than those shown. The components shown, however, are sufficient to disclose an illustrative embodiment for practicing the invention.

As shown in the figure, computing device 20 includes at least one processing unit 22 in communication with a main memory 24 via a bus 23 or other means. Main memory 24 generally includes a RAM 26 as well as ROM (not shown) and/or other storage means. Main memory 24 illustrates a type of computer-readable media, namely computer storage media. Computer storage media may include volatile and nonvolatile, removable and non-removable media implemented in any method or technology for storage of information such as computer-readable instructions, data structures, program modules or other data. Other examples of computer storage media include EEPROM, flash memory or other semiconductor memory technology, optical storage media, magnetic cassettes, magnetic tape, magnetic disk storage or other magnetic storage devices, or any other medium which can be used to store data and which can be accessed by a computing device.

Main memory 24 stores an operating system 28 for controlling the operation of computing device 20. Main memory 24 further is used to store executing programs, including application programs 30, and data. Programs include computer-executable instructions capable of execution by processing unit 22 and may include, for example, programs for data collection 32; a data warehouse server 34 or other database server application; data analysis 36, which may be associated with the operation of a data warehouse for analysis of aggregated information regarding online games and game participants; a game client 38 which interacts with an online game service to enable device 20 to participate in an online game; a game server 40 such as may be run by third-party game service 17; and a portal server 42 such as may be run by portal service 16. A server device configured much like device 20 may also include a games monitor application 44 that monitors activities of online game services and network game traffic. Programs 30 further include programs for enabling communication with another electronic device, as for example by way of a network.

Computing device 20 also includes an input/output interface 46 for communicating with peripheral devices such as a keyboard, mouse, wheel, joystick, rocker switches, keypad, printer, scanner, and/or other input devices not specifically shown in FIG. 2. A user of computing device 20 can use input/output devices to interact with device 20 by way of a user interface that may be distinct from or integrated with operating system 28 and/or programs 30-42. Interaction with the user interface includes visual interaction by way of a display and a video display adapter 48.

Computing device 20 may include at least one magnetic hard disk 52 for nonvolatile storage of data. Hard disk 52 may be used for storage of files and other data and may be used in implementing a relational or other form of database, a data warehouse, and the like. Computing device 20 may include a removable media drive 54. Removable media drive 54 may comprise one or more of an optical disc drive, a floppy disk drive, and a tape drive. and/or a permanent media drive 46 for computer-readable storage media. Removable media drive 44 can comprise one or more of an optical disc drive, a floppy disk drive, and/or a tape drive. Permanent or removable storage media may include volatile, nonvolatile, removable, and non-removable media implemented in any method or technology for storage of information. Computing device 20 may also or alternatively include one or more other secondary storage devices.

By way of network interface 50, computing device 20 can communicate with a LAN, a WAN, a wired telephone network, a telephone network, or some other communications network, such as network 15 in FIG. 1. Network interface 50 may include a transceiver, a network interface card (NIC), and the like.

Exemplary Architecture

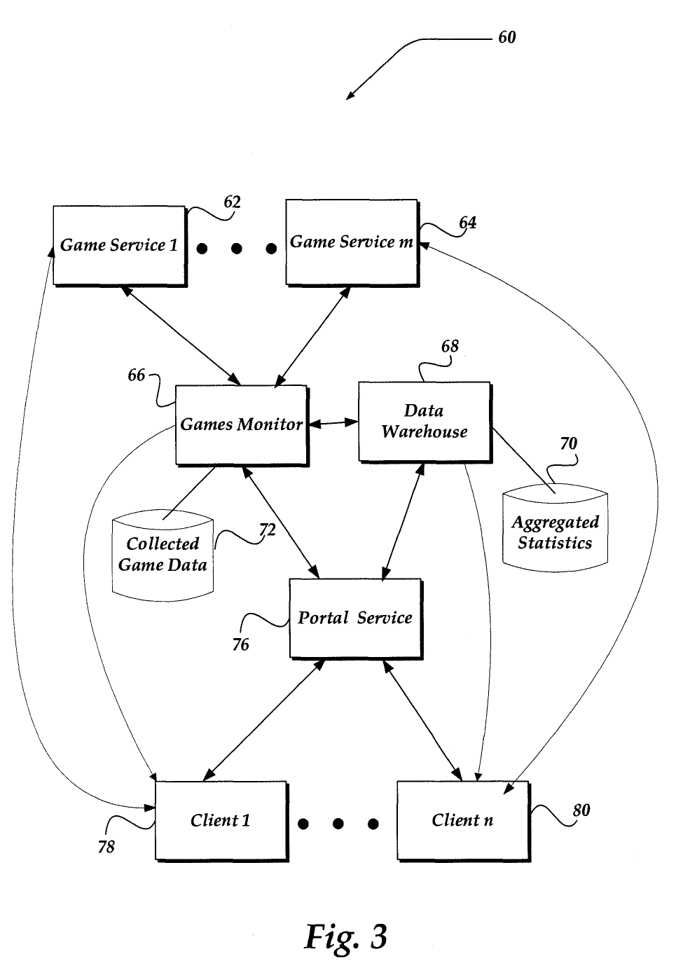

FIG. 3 illustrates one embodiment of an architecture for the present invention. However, not all of the illustrated elements may be required to practice the invention, and variations in the arrangement and type of the components may be made without departing from the spirit or scope of the invention. Certain components shown in the figure may interact and communicate by way of a network (not shown) and/or by other means.

As shown in FIG. 3, game clients 78-80 may communicate with game services 62-64 to participate in one or more online, multiplayer games. A games monitor 66 also communicates with game service providers 62-64, repeatedly or periodically collecting data relating to games and game participants. Such data may include essentially any information regarding the game and users participating in the game, such as numbers of users connected, their names and scores, the maps currently being played, and so on. Games services 62-64 may include public master servers made available by providers of particular online multiplayer games and accessible to games monitor 66. Games monitor 66 may also be employed to provide a service to clients, such as game clients 78-80 running a browser application, to determine which online game services are available and the network performance of servers associated with those game services. Games monitor 66 may be independent of portal service 76 and game services 62-64 or may be combined with one or more of them.

Portal service 76 may act as an intermediary between game clients and a wide variety of game services. Games monitor 66 may alternatively be hosted on a server of portal service 76, one of game services 62-64, or another related service. Games monitor 66 may provide information services related to a wide variety of games and game providers. Accordingly, games monitor 66 may comprise a collection of monitors that may or may not be directly associated with particular games and/or game services. Associated with games monitor 66 is a database of collected game data 72.

A data warehouse 68 communicates with games monitor 66 to collect, store, and analyze aggregated data regarding games, including data relating to particular games and game services and game participants who play online games by way of game clients such as game clients 78-80. In one embodiment, data warehouse 68 communicates with games monitor 66 at regular intervals (for example, approximately every thirty seconds) and obtains data collected by games monitor 66. Data warehouse 68 stores the data in a repository of aggregated statistics 70. Data warehouse 68 or an application or service in communication with data warehouse 68 may then be employed to analyze the aggregated data and calculate statistics based on the data. In particular, the data may be analyzed with respect to various dimensions (for example: game, player, game server, time, and location). Data warehouse 68 may be independent of portal service, game service, and games monitor. Alternatively, data warehouse may be hosted on a server of portal service, game service, games monitor, or another related service.

Analyzed data can be used to calculate various useful kinds of information about online games. Data analyzed at or by way of data warehouse 68 include data relating to games, to users, and to “clans” (groups of users). At the game level, some examples of analyzed information include how many minutes of game-playing were played per month; how many minutes per person were played per month; how many minutes per game per person were played per month; most popular map for each game during a particular time period; and details of the active game participant population over a particular time period. In one embodiment, analyzed data and calculated data may be obtained from data warehouse 68 by portal service 76, which then may perform further analysis on the data and publish the data at a website. Such information may include information of particular current interest, such as the currently most popular game, or the currently most popular map for a particular game.

At the user level, analyzed information may include aggregate information concerning particular game players over time and over all games played. Such information may be captured in profiles of individual users, which may be performed at or by way of a data warehouse 68 or portal service 76, or another facility. A user profile may include a history of the user's game playing and other information. The profile may show, for example, which games a user tends to play, which games the user is good at, which games the user prefers to play, which games the user has recently begun to play, and so forth. The profile may provide further analysis of such information. For example, the scores of the user may be compared with the scores of other users against whom the user was playing, and from such information an ability level measure for users may be calculated and included in user profiles.

Such calculations may in turn be used to establish rankings of all users that data warehouse 68 is employed to track. Rankings of users with respect to particular games may be provided, as well as rankings based on an aggregate calculation of ability across more than one game. Rankings in general change over time as information regarding the universe of users is updated (for example, particular users improve at certain games and get worse at other games). Changes in a user's performance over time may also be measured and published by way of portal service 76 (for example, a graph of a curve showing a user's improvement may be displayed).

In addition to publishing analyzed information and statistics, data warehouse 68, games monitor 66 and/or portal service 76 may be employed to provide intelligent matchmaking services for users seeking to participate in games with suitable players, so that users may have a more customized or challenging game-playing experience. The matchmaking permits the user to participate in a game that has the characteristics and settings that approximate the user's preferences. In one embodiment, a user is permitted to request matching with players approximately at the user's level, or to be challenged with players at a higher ability level. Given that a (published) ranking of player abilities is also maintained, a user can seek to move higher in the ranking by requesting matching with players of higher ability levels.

Data relating to groups or “clans” of (generally self-identified) users who tend to play games together may also be collected, integrated, analyzed and published. Moreover, such clan-level information may then be used to provide profiles and rankings of clans. Furthermore, matchmaking services may be provided to clans based on this information, so that, for example, the best and second-best clans for a particular game may be identified, and tournaments may be organized in which they may compete.

Exemplary Operations for Data Analysis and User/Clan Matchmaking

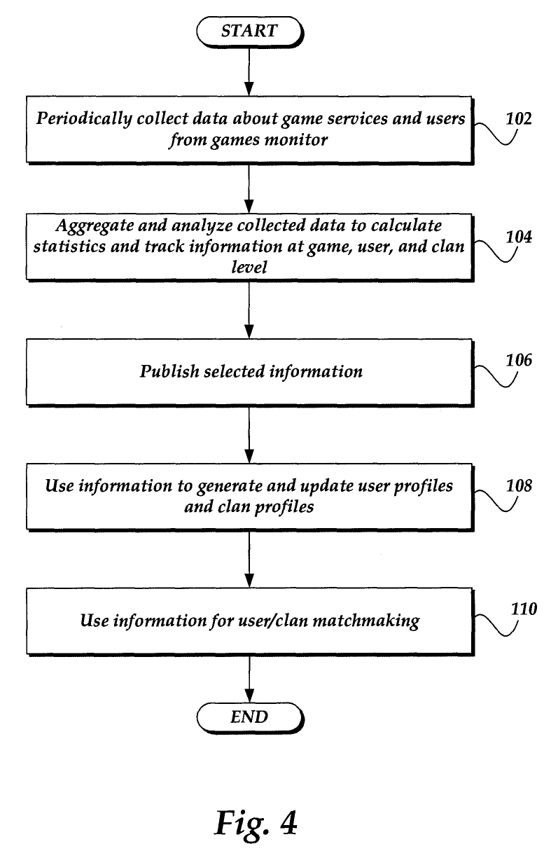

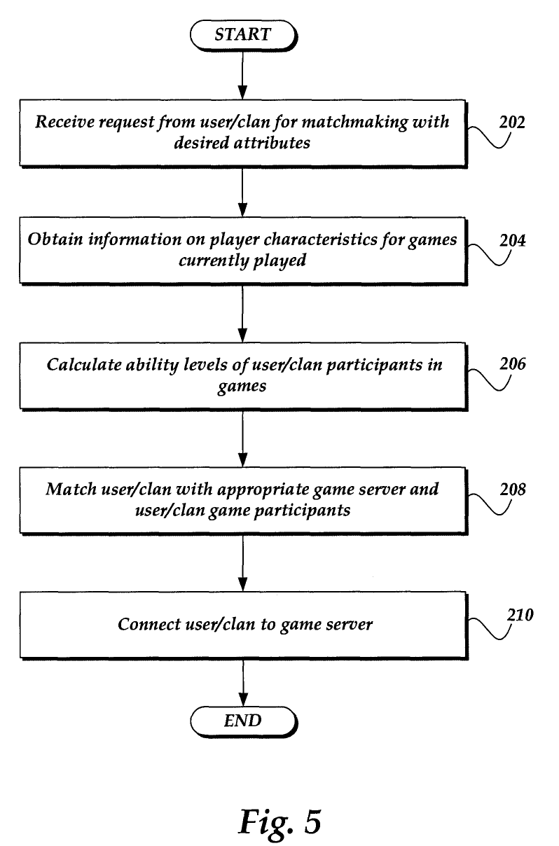

FIG. 4 is a flow diagram illustrating an exemplary process for collection and analysis of data relating to online multiplayer games according to one embodiment of the invention. At block 102, a facility, such as a data warehouse or a facility in communication with a data warehouse, periodically contacts a games monitor or the like to obtain data collected by the monitor relating to available online game services and users playing games by way of the game services. At block 104, the data warehouse is employed to aggregate the data from various game services and perform analysis of the collected data to calculate various kinds of statistics relating to games and game users. In particular, data is tracked and analyzed according to game, user, and user clan, as well as with respect to various other dimensions and metrics, which may cover a variety of unrelated game services. At block 106, certain information relating to game statistics is published, for example on a website, and thus is made available to game users and potential game users. At block 108, collected information is used to generate and update profiles of game users and of clans of game users. At block 110, collected information is employed for game user and/or game user clan matchmaking services, as illustrated further in FIG. 5. It will be understood that the elements of the process illustrated in FIG. 4 need not be performed in the order shown and that the process is in general one that is repeated, so that, for example, game user profiles are continually updated as data collected on games and game users results in changed statistics. Moreover, not all elements of the illustrated process are necessary to practice the present invention.

FIG. 5 is a flow diagram illustrating an exemplary general process for matching a game user or clan with other game users or clans, in accordance with the invention. At block 202, a request for matchmaking for a particular game is received from a user (or user clan). The request may specify desired attributes of matched players (for example, a user may request to be matched with other users at or exceeding the user's ability level). At block 204, appropriate information for matchmaking purposes on user or clan characteristics is obtained, for example by way of a data warehouse, a repository of user or clan profiles, or the like. At block 206, ability levels of users or clans are calculated if not already calculated. At block 208, the user or clan is matched with one or more other users or clans based on the obtained and/or calculated information. At block 210, the user or clan making the matchmaking request is connected to the game server to which the matched users or clans are connected. It will be understood that the elements of the process illustrated in FIG. 5 need not be performed in the order shown, and that not all elements are necessary in order to practice the invention.

The above specification provides a complete description of the manufacture and use of the composition of the invention. However, other embodiments will be clear to those having skill in the art. Since many embodiments of the invention can be made without departing from the spirit and scope of the invention, the invention resides in the claims hereinafter appended.

What is claimed as new and desired to be protected by Letters Patent of the United States is:

1. A method for providing information relating to a game played over a network, comprising:
obtaining data collected by a games monitor, wherein the games monitor obtains the data from a plurality of online game services;
analyzing the data according to at least one dimension; and
providing the analyzed data to a game user.

2. The method of claim 1, wherein at least some of the online game services are third-party online game services.

3. The method of claim 1, further comprising maintaining the data in a data warehouse.

4. The method of claim 1, wherein the at least one dimension comprises at least one of the following: a game dimension, a player dimension, a game server dimension, a time dimension, and a location dimension.

5. The method of claim 1, wherein analyzing the data includes analyzing performance of a game participant in at least two games.

6. The method of claim 1, wherein analyzing the data includes calculating an ability level for a game participant.

7. The method of claim 1, wherein analyzing the data includes measuring a change in performance by a game participant.

8. The method of claim 1, wherein providing the analyzed data further comprises providing at least one of the following: a profile of a user and a profile of a group of users.

9. The method of claim 1, wherein analyzing the data includes analyzing data for a group of users.

10. The method of claim 1, wherein obtaining the data collected by the games monitor is performed periodically.

11. The method of claim 1, wherein providing the analyzed data further comprises providing a matched game participant to the user.

12. The method of claim 1, wherein the game user operates a mobile device.

13. A computer-readable medium having executable instructions for providing information relating to a game played over a network, comprising:
obtaining data collected by a games monitor, wherein the games monitor obtains the data from a plurality of online game services;
analyzing the data according to at least one dimension; and
providing the analyzed data to a game user.

14. A modulated data signal for communicating over a network, the modulated data signal comprising instructions that enable a computing device to provide information relating to a game played over a network, wherein the instructions comprise:
obtaining data collected by a games monitor, wherein the games monitor obtains the data from a plurality of online game services;
analyzing the data according to at least one dimension; and
providing the analyzed data to a game user.

15. A computing apparatus configured for providing information relating to a game played over a network, comprising:
a memory for storing instructions and data; and
a processor in communication with the memory, wherein the processor performs actions based at least in part on the stored instructions, including:
obtaining data collected by a games monitor, wherein the games monitor obtains the data from a plurality of online game services;
analyzing the data according to at least one dimension; and
providing the analyzed data to a game user by way of a communications interface.

16. The computing apparatus of claim 15, wherein the apparatus is a server device.

17. The computing apparatus of claim 15, wherein the apparatus is a client device.

18. A method for matching a first user with a second user for participating in a game played over a network, comprising:
obtaining information about the first user and the second user by collecting data from a plurality of online game services;
receiving a matchmaking request from the first user, wherein the request includes at least one desired attribute;
determining an ability measurement for at least one participant in at least one instance of the game; and
selecting the second user for matching from among the at least one participant based on the at least one desired attribute and the ability measurement.

19. The method of claim 18, wherein the online game services are third-party online game services.

20. The method of claim 18, wherein the information is obtained from a games monitor regarding current instances of the game, and wherein the games monitor is in communication with the plurality of online game services.

21. The method of claim 18, wherein determining the ability measurement further comprises employing a data warehouse to analyze data relating to game participants.

22. The method of claim 18, wherein the at least one desired attribute comprises a desired ability level.

23. The method of claim 18, wherein the first user belongs to a first group of users, and wherein selecting the second user for matching further comprises selecting a second group of users.

24. The method of claim 18, wherein at least one of the first user and the second user operates a mobile device.

25. A computer-readable medium having executable instructions for matching a first user with a second user for participating in a game played over a network, comprising:
obtaining information about the first user and the second user by collecting data from a plurality of online game services;
receiving a matchmaking request from the first user, wherein the request includes at least one desired attribute;
for at least one participant in at least one instance of the game, determining an ability measurement; and
selecting the second user for matching from among the at least one participant based on the at least one desired attribute and the ability measurement.

26. A modulated data signal for communicating over a network, the modulated data signal comprising instructions that enable matching a first user with a second user for participating in a game played over a network, wherein the instructions comprise:
obtaining information about the first user and the second user by collecting data from a plurality of online game services;
receiving a matchmaking request from the first user, wherein the request includes at least one desired attribute;
for at least one participant in at least one instance of the game, determining an ability measurement; and
selecting the second user for matching from among the at least one participant based on the at least one desired attribute and the ability measurement.

27. A computing apparatus configured to enable matching a first user with a second user for participating in a game played over a network, comprising:
a memory for storing instructions;
a communications interface in communication with the first user and the second user; and
a processor in communication with the memory and the communications interface, wherein the processor performs actions based at least in part on the stored instructions, including:
obtaining information about the first user and the second user by collecting data from a plurality of online game services;
receiving a matchmaking request from the first user, wherein the request includes at least one desired attribute;
for at least one participant in at least one instance of the game, determining an ability measurement; and
selecting the second user for matching from among the at least one participant based on the at least one desired attribute and the ability measurement.
